(19) United States
(12) Patent Application Publication
(10) Pub. No.: US 2020/0377285 A1
(43) Pub. Date: Dec. 3, 2020

(54) BEVERAGE INSULATOR AND PROTECTOR, PROCESS OF MAKING, AND METHOD OF USE

(71) Applicant: Jay C. Beckham, Fort Worth, TX (US)

(72) Inventor: Jay C. Beckham, Fort Worth, TX (US)

(21) Appl. No.: 16/887,468

(22) Filed: May 29, 2020

Related U.S. Application Data
(60) Provisional application No. 62/853,861, filed on May 29, 2019.

(51) Int. Cl. B65D 81/38; B29C 45/14

(52) U.S. Cl. CPC B65D 81/3876; B29L 2031/7158; B29C 45/14336

(57) ABSTRACT

A beverage insulator system, process of making, and method of use is presented having an aesthetic shape which improves upon ergonomics and visual appeal. The beverage insulator system, process of making, and method of use presented herein provides a better user experience while also providing an increased product life, with rigid durability while still allowing user comfort. The beverage insulator system, process of making, and method of use presented herein causes maximum retardation of heat transfer through the injection of insulating plastics, as well as other thermal resistance properties. Additionally, the beverage insulator system, process of making, and method of use secures beverage containers within in close and tight tolerances to prevent and/or reduce rattle.

### CROSS-REFERENCE TO RELATED APPLICATIONS

The present application claims priority to U.S. Provisional Patent Application No. 62/853,861 which was filed on May 29, 2019, which is hereby incorporated by reference herein in its entirety, including any figures, tables, or drawings.

### FIELD OF THE DISCLOSURE

This disclosure relates to a beverage insulator and protection system. More specifically and without limitation, this disclosure relates to a beverage bottle insulator system for retardation of heat and protection, related process for making, and related method of use.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright Jay C. Beckham. All rights reserved.

### BACKGROUND OF THE DISCLOSURE

Frequently, people like to enjoy a cold and/or warm beverage. Whether cold or warm, coffee, water, tea, beer, wine or any other beverage, people often enjoy their beverages at a temperature which is not the ambient temperature of their surroundings. Whether in a social setting such as a bar or attending a sporting event such as a football game, enjoying a cold beverage may be difficult in places where ambient temperatures do not match that of the beverage. Additionally, enjoying a warm beverage may be equally difficult depending on the season, location, method of using, and more. Very infrequently do ambient temperatures match the temperature of a desired beverage.

Some forms of beverage insulators are known in the art. Beverage insulators have been in use for many years. One example is a “Koozie”, which is a fabric or foam sleeve that is designed to thermally insulate a beverage container, like a can or bottle. These insulated beverage containers are used to insulate a chilled beverage from warming or a warm beverage from cooling. These effects are caused by ambient temperature, heat transfer, and additional factors such as air movement and/or sunlight. Using an insulated beverage container can reduce the rate a drink warms or cools.

Typically, an insulated beverage container, such as the “Koozie” branded insulator product is limited in scope, effectiveness, and versatility. Thus, a better beverage insulator is needed. Existing beverage insulators use materials such as leather, polyester, vinyl, or at best foam. These materials are limiting, yet no one has found another method or a different material which is better for the production of beverage insulators. Furthermore, there exist no beverage insulators in the art which use a material which is environmentally friendly while also achieving the goals of the beverage container insulator described herein.

Typically, beverage container insulators are ineffective. One of the main reasons existing beverage containers are ineffective is that they still allow cold drinks to warm and warm drinks to cool. This leaves many cold beverages, such as beer, ice tea, and any other cold beverage, or even ice, warming and going unconsumed. This leads to waste generation. Compile this issue with the fact that much beer is consumed, and humans don't desire to add ice to beer to cool their beverage. Beer is one example, however many beverages are worsened with ice.

Even in modest ambient temperatures, cool beverages warm quickly when existing, ineffective, beverage container insulators are used. Furthermore, add a human hand gripping the insulator and more heat is added to the mix. In some studies, beer that is held in a “koozie” will warm faster than a beer not held, without a “koozie”. Existing beverage container insulators are simply deficient.

Typically beverage insulators are limited in shapes and sizes. Existing beverage container insulators are limited in the portions of a beverage container they are able to cover. Most insulators aren't designed to cover much of the surface area of a beverage container. Other insulators aren't designed to be ergonomic. Still other insulators aren't designed to fit in close and tight tolerances with a beverage container such that the beverage container jolts about within the insulator causing clunking, clanking, rattling, or screeching. The disclosure herein introduces novel features that address these long-standing issues and many more.

The result of a fall, drop, bump, or other contact can often be troublesome and even dangerous when a beverage container is involved in the accident. This poses a problem for many beverage containers. Many beverage containers are made from glass or metal. Glass is subject to shatter or break when exposed to a drop or severe bump. This can be dangerous for adults, children, animals, or anything else near the location of the break as shattering glass tends to spread. Additionally, this can cause a mess both in the glass which shatter and spreads, as well as with the liquid and/or other substance within the beverage container. The disclosure herein is designed to withstand and/or prevent damage to the beverage container held within in the event of a fall, bump, and/or other breaking and/or traumatic event. This improves upon the safety and well-being of all those who are in close proximity, protecting any type of beverage container from breaking and/or losing its contents; causing a spilling hazard.

Once opened, many beverage containers such as aluminum cans, glass bottles, and more can not be resealed without industrial level manufacturing equipment. Consumers may wish to reseal or cover the contents of the beverage container. Even a beverage container which has not been opened yet, may wish to be covered, for the purposes of insulating, protecting, and more. The disclosure herein presents a novel method of enclosing the beverage container with a lid that is suitable for such a task. The enclosure device discussed herein as part of the beverage insulator system can be used to enclose a beverage container both before and after the beverage container has been opened. Furthermore, the enclosure device, and/or lid disclosed herein serves as additional insulation at a portion of the beverage container which has never been insulated by beverage insulators successfully, that exist in the art.

In addition to these problems, which face many at a local level, another, less microscale problem facing humans today is plastic pollution. Plastic pollution is a large, and growing, environmental problem facing the Earth today. Plastic pollution is the accumulation of plastic objects, such as plastic bottles and more, in the Earth's environment that adversely affects the world's cities, the world's human populations, wildlife, wildlife habitat, and humans. Plastics are inexpensive and durable, and as a result, levels of plastic production are high. The chemical structure of plastics renders them resistant to many natural processes of degradation, and as a result, they are slow to degrade. These two factors, and more, have led to a high prominence of plastic pollution, thus any means of reducing plastic pollution will help improve the environment.

Thus, there is a need in the art for an improved beverage insulator, process of making, and method of use. Some of these needs have been felt in the art but have all remained unsolved for a long time. Many products have hit the market since the “Koozie” branded insulator originally hit the market in 1980, yet none of these other insulators solve any, yet alone, all of these issues, and more. Thus, the beverage insulator system, process of making, and method of use presented herein solve these problems, and in addition to solving these long-felt needs come up with novel features that improve upon the state of the art and improve upon the lifestyle of those using the beverage insulator system, but also improves upon the lives of those not using by finding novel uses for plastic pollution.

Presented herein, is a process of making the beverage insulator system from recycled plastic. The beverage insulator system presented herein can be mostly made of recycled plastic, and/or completely made of recycled plastic. Typical beverage insulators, processes of making, and methods of use are inadequate.

### SUMMARY OF THE DISCLOSURE

A beverage insulator system, process of making, and method of use is presented herein. Accordingly, it is a principal object of the disclosure to provide a beverage insulator system, process of making, and method of use.

Furthermore, it is a principal object of the disclosure to provide a beverage insulator system, process of making, and method of use that improves upon the state of the art.

Another object of the disclosure is to provide a beverage insulator system, process of making, and method of use that is lightweight and provides enhanced ergonomics.

Yet another object of the disclosure is to provide a beverage insulator system, process of making, and method of use that is relatively lightweight.

Another object of the disclosure is to provide a beverage insulator system, process of making, and method of use that is easy and fun to hold.

Yet another object of the disclosure is to provide a beverage insulator system, process of making, and method of use that is easy to grip.

Another object of the disclosure is to provide a beverage insulator system, process of making, and method of use that has multiple gripping locations.

Yet another object of the disclosure is to provide a beverage insulator system, process of making, and method of use that is durable.

Another object of the disclosure is to provide a beverage insulator system, process of making, and method of use that has structural rigidity.

Yet another object of the disclosure is to provide a beverage insulator system, process of making, and method of use that can accomodate beverage containers of varying sizes.

Another object of the disclosure is to provide a beverage insulator system, process of making, and method of use that can secure a beverage container.

Yet another object of the disclosure is to provide a beverage insulator system, process of making, and method of use that can quickly and firmly secure a beverage container.

Another object of the disclosure is to provide a beverage insulator system, process of making, and method of use that reduces beverage container rattle.

Yet another object of the disclosure is to provide a beverage insulator system, process of making, and method of use that does not self-loosen.

Another object of the disclosure is to provide a beverage insulator system, process of making, and method of use that eliminates screeching from beverage container movement and install.

Yet another object of the disclosure is to provide a beverage insulator system, process of making, and method of use that has multiple load and release methods.

Another object of the disclosure is to provide a beverage insulator system, process of making, and method of use that provides a beverage container protection.

Yet another object of the disclosure is to provide a beverage insulator system, process of making, and method of use that provides a beverage container protection in the event of drop.

Another object of the disclosure is to provide a beverage insulator system, process of making, and method of use that can be enclosed by a lid.

Yet another object of the disclosure is to provide a beverage insulator system, process of making, and method of use that is easy to use.

Another object of the disclosure is to provide a beverage insulator system, process of making, and method of use that is safe to use.

Yet another object of the disclosure is to provide a beverage insulator system, process of making, and method of use that is fun to use.

Another object of the disclosure is to provide a beverage insulator system, process of making, and method of use that can be used repeatedly.

Yet another object of the disclosure is to provide a beverage insulator system, process of making, and method of use that is sustainable.

Another object of the disclosure is to provide a beverage insulator system, process of making, and method of use that is user friendly.

Yet another object of the disclosure is to provide a beverage insulator system, process of making, and method of use that maintains the temperature of a beverage.

Another object of the disclosure is to provide a beverage insulator system, process of making, and method of use that can alter the temperature of a beverage.

Yet another object of the disclosure is to provide a beverage insulator system, process of making, and method of use that is durable.

Another object of the disclosure is to provide a beverage insulator system, process of making, and method of use that is capable of a quick change out and/or replacement of one beverage container to another.

Yet another object of the disclosure is to provide a beverage insulator system, process of making, and method of use that is lightweight.

Another object of the disclosure is to provide a beverage insulator system, process of making, and method of use that has a long useful life.

Yet another object of the disclosure is to provide a beverage insulator system, process of making, and method of use that is environmentally friendly.

Another object of the disclosure is to provide a beverage insulator system, process of making, and method of use that is high quality.

These and other objects, features, or advantages of the present disclosure will become apparent from the specification and claims.

To meet the above objectives, a beverage insulator system, process of making, and method of use is presented having an aesthetic shape which improves upon ergonomics and visual appeal. The beverage insulator system, process of making, and method of use presented herein provides a better user experience while also providing an increased product life, with rigid durability while still allowing user comfort. The beverage insulator system, process of making, and method of use presented herein causes maximum retardation of heat transfer through the injection of insulating plastics, as well as other thermal resistance properties. Additionally, the beverage insulator system, process of making, and method of use secures beverage containers within in close and tight tolerances to prevent and/or reduce rattle. Additionally, the beverage insulator system, process of making, and method of use presented herein includes a lid to secure and/or remove a beverage container from the beverage insulator system. The lid of the beverage insulator system presented herein, is easy to use and able to secure a beverage container in place in 2-3 turns, or even less for quick insertion or removal of a beverage container.

Furthermore, the beverage insulator system, process of making, and method of use presented herein is environmentally friendly. The process of making the beverage insulator system can be completed entirely and/or almost entirely from the use of recycled plastics.

The method of using the beverage insulator system improves dramatically on the state of the art. While old beverage insulator systems were difficult, cumbersome, and often noisy, the current method of using them is quick, efficient, fun, safe, easy, and reliable.

### BRIEF DESCRIPTION OF THE DRAWINGS

FIG. 1 is a top, perspective view showing a beverage insulator system; the view showing the beverage insulator system having a body; the view showing the body having a plurality of panels situated for grip; the view showing an insulated lid; the view showing an attached barkey; the view showing the lid engaged with the body;

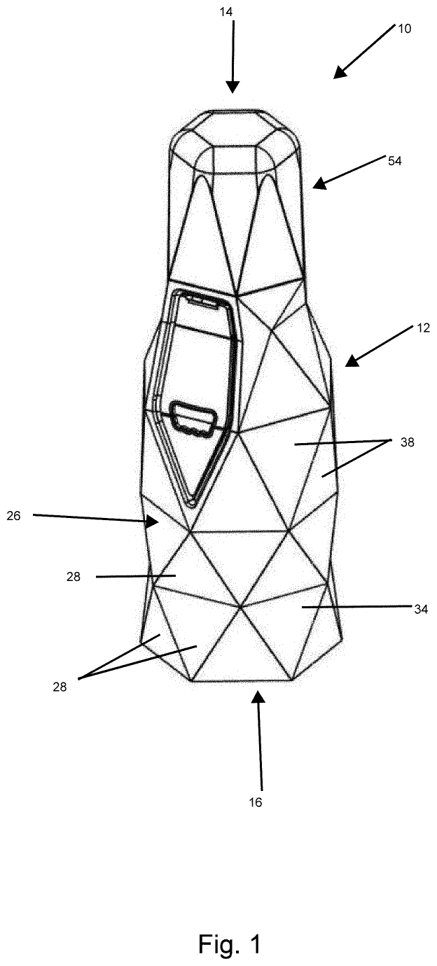

FIG. 2 is a side, elevation view showing a beverage insulator system; the view showing the beverage insulator system having a body; the view showing the body having a plurality of panels situated for grip; the view showing an insulated lid; the view showing an attached barkey; the view showing the lid engaged with the body; the view showing a display area located in one of the plurality of panels;

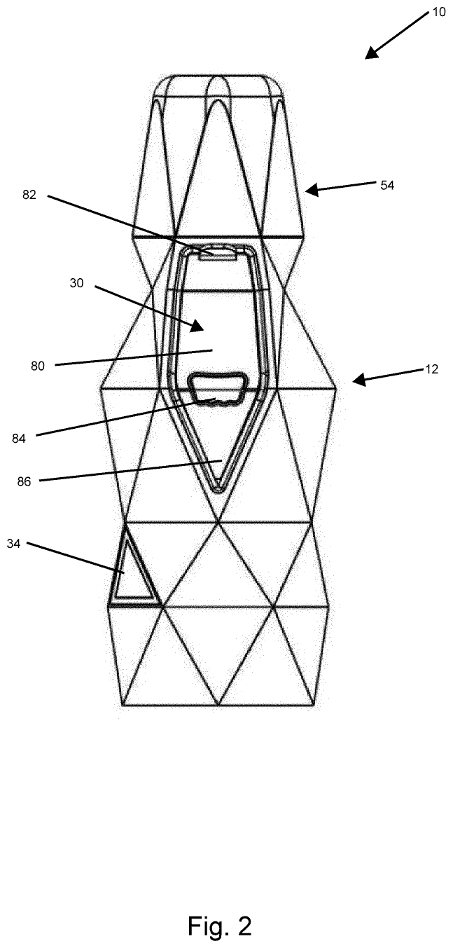

FIG. 3 is a side, elevation view showing a beverage insulator system; the view showing the beverage insulator system having a body; the view showing the body having a plurality of panels situated for grip; the view showing an insulated lid; the view showing an attached barkey; the view showing the lid engaged with the body; the view showing a display area located in one of the plurality of panels;

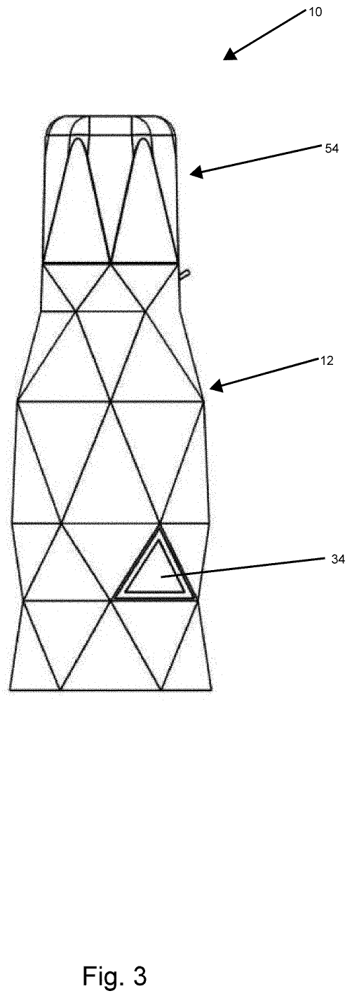

FIG. 4 is a side, elevation view showing a beverage insulator system; the view showing the beverage insulator system having a body; the view showing the body having a plurality of panels situated for grip; the view showing an insulated lid; the view showing an attached barkey; the view showing the lid engaged with the body;

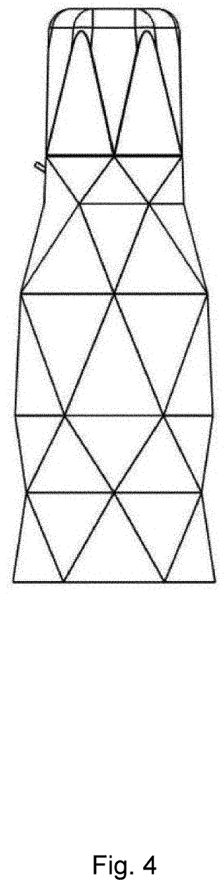

FIG. 5 is a side, elevation view showing a beverage insulator system; the view showing the beverage insulator system having a body; the view showing the body having a plurality of panels situated for grip; the view showing an insulated lid; the view showing an attached barkey; the view showing the lid engaged with the body;

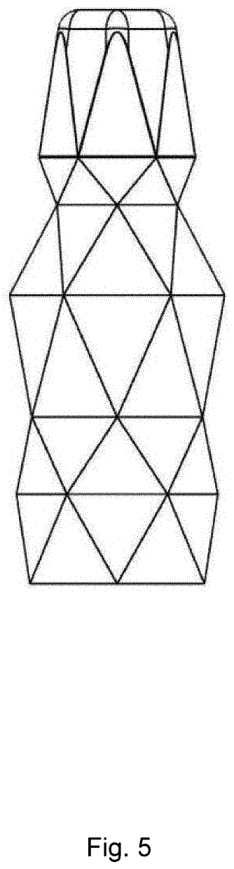

FIG. 6 is a top view showing a beverage insulator system; the view showing the beverage insulator system having a body; the view showing the body having a plurality of panels situated for grip; the view showing an insulated lid; the view showing an attached barkey; the view showing the lid engaged with the body;

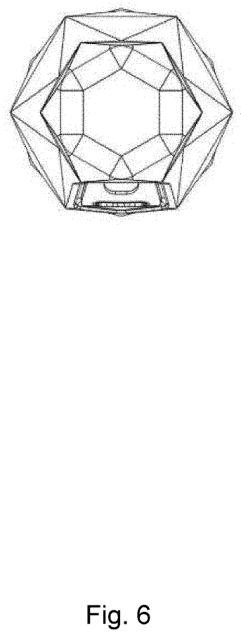

FIG. 7 is a bottom view showing a beverage insulator system; the view showing the beverage insulator system having a body; the view showing the body having a plurality of panels situated for grip; the view showing an insulated lid; the view showing an attached barkey; the view showing the lid engaged with the body; the view showing a thermally insulated bottom lid in an engaged position; the lid having a handle and an indent;

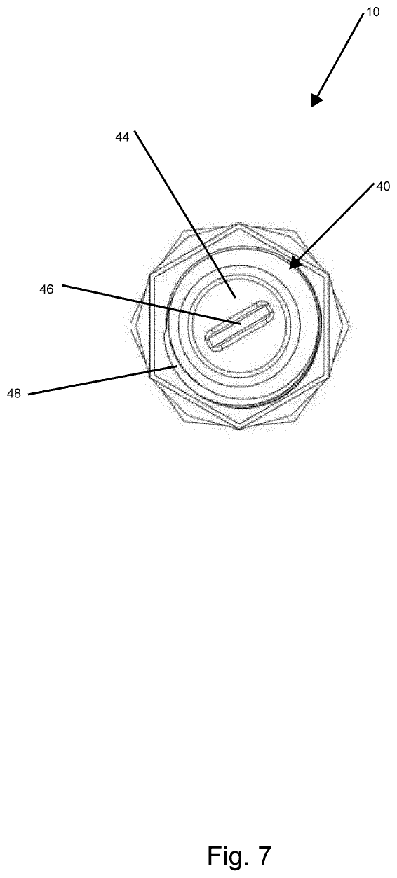

FIG. 8 is a bottom, perspective view showing a beverage insulator system; the view showing the beverage insulator system having a body; the view showing the body having a plurality of panels situated for grip; the view showing an insulated lid; the view showing an attached barkey; the view showing the lid engaged with the body; the view showing a thermally insulated bottom lid in an engaged position; the lid having a handle and an indent;

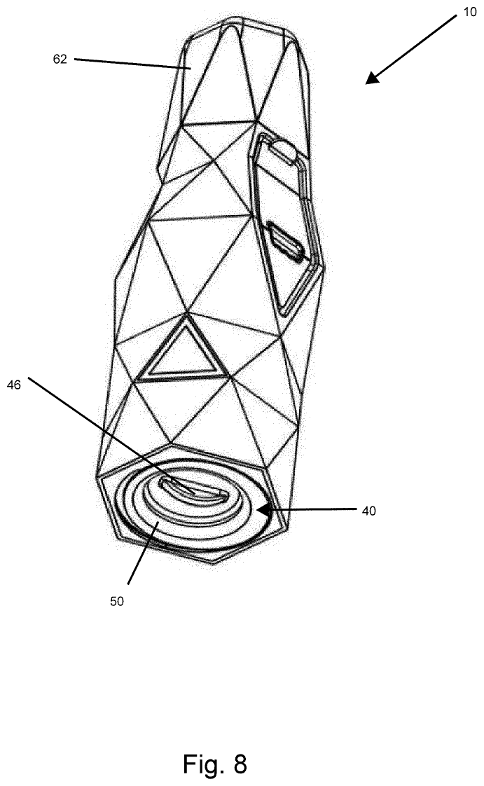

FIG. 9 is an isometric view showing a beverage insulator system; the view showing the beverage insulator system having a body; the view showing the body having a plurality of panels situated for grip; the view showing an insulated lid; the view showing a separated barkey; the view showing the lid disengaged with the body; the view showing a thermally insulated bottom lid in a disengaged position; the lid having a handle and an indent; the view showing a bottle;

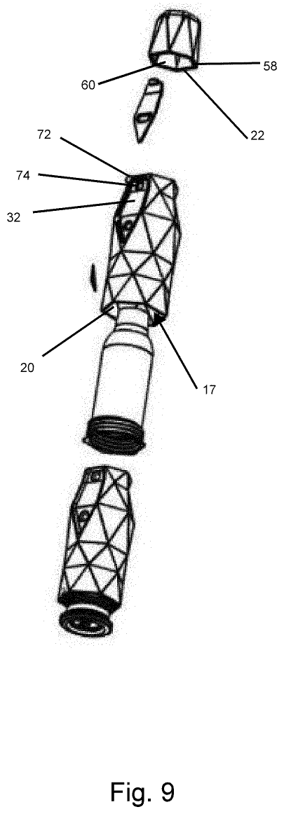

FIG. 10 is a cross-section view showing a beverage insulator system; the view showing the beverage insulator system having a body; the view showing a printed plastic wall within injected thermal molding; the view showing the body having a plurality of panels situated for grip; the view showing an insulated lid; the view showing an attached barkey; the view showing the lid engaged with the body; the view showing a thermally insulated bottom lid in an engaged position; the lid having a handle and an indent; the view showing a cap feature within the lid which closes a previously opened bottle; the cap feature in the engaged position sealing the top of the bottle; the view showing a bottom lid rotationally engaged.

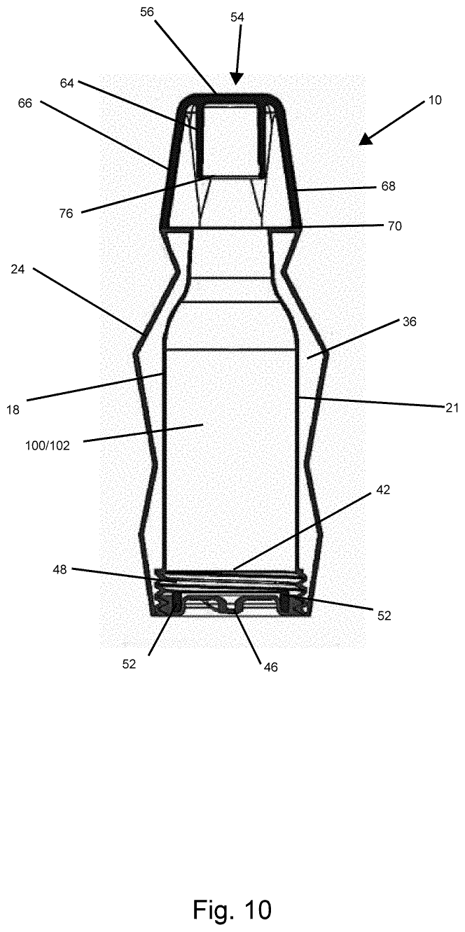

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

System:

With reference to the figures, a beverage insulator system 10 is presented. Beverage insulator system 10 is formed of any suitable size, shape and design. In the arrangement shown, as one example, beverage insulator system 10 includes a body 12, a bottom cover 40, and lid 54, among other components.

Body:

Body 12 is formed of any suitable size, shape and design and forms the main portion of the beverage insulating system. Body 12 may be formed of any beverage holding shape such as a cup, a mug, a travel mug, a thermal mug, or the like. In one arrangement, as is shown, body 12 includes a sidewall 18 that extends in a generally circular manner from an upper end 14 to a lower end 16.

Sidewall 18 connects at or near its lower end 16 to a connecting feature 22 that defines the bottom of the hollow interior 17 formed by the body 12. Sidewall 18 terminates in an open upper end 14, after tapering a small degree inward, to which lid 54 is operably connected.

In the arrangement shown, as one example, sidewall 18 forms the hollow interior 17. Hollow interior 17 is lined by the inner wall 20 of the interior surface 21 of the body 12. In the arrangement shown, as one example, the inner wall 20 and/or sidewall 18 and top 42 of the bottom cover 40 are formed of a plastic which eliminates metal on glass and/or glass on glass “screeching”. The recycled material of the surfaces which come into contact with the beverage container prevent any screeching, loud noises, or unwanted sounds. In the arrangement shown, as one example, these surfaces are made from recycled plastic. However, any other material which prevents unwanted sounds of scratching, grinding, lurching, shaking, and/or screeching is hereby contemplated for use.

In one arrangement, as is shown, the bottom of the hollow interior 17 includes a connecting feature 22. Connecting feature 22 may be formed of any suitable size, shape, and design and is configured to connect the body 12 to the bottom cover 40. In the arrangement shown, as one example, connecting feature 22 is formed of a course threading. However, any connecting feature is hereby contemplated for use, including but not limited to threads, snap-fit-features, frictional-fit-features, twist locking features, and the like. This connecting feature 22 is used to connect the bottom cover 40 to the body 12 in a manner that allows bottom cover 40 to be tightened, loosened, and/or removed entirely. Furthermore, in the arrangement shown, as one example, connecting feature 22 is an extended thread design so as to accommodate varying 12 oz. bottle lengths. While a bottle is shown in the example, other beverage containers are hereby contemplated for use. In the arrangement shown, as one example, the extended thread feature of the connection feature 22 allows the bottom cover 40 to secure a bottle, or other beverage container, securely within the hollow interior 17 of the body 12 within 2-3 turns or even less. This feature is also known as a quick load feature.

In one arrangement, as is shown, sidewall 18 extends upward from the connection feature 22 at the lower portion of the body 12. Sidewall 18 extends upward to the upper end 14 of the body 12 where a lid 54 is operably connected to the body 12. Lid 54 connects to the upper end 14 of body 12 by frictional fit. However, other connection means are hereby contemplated for use including but not limited to threads, snap-fit-features, frictional-fit-features, twist locking features, and the like.

In one arrangement, as is shown, body 12 is formed of an inner wall 20 and an outer wall 24 which are filled with a thermal medium 36 placed therebetween. Thermal medium 36 may be formed of any suitable size, shape, and design and is formed to prevent heat transfer to and from the hollow interior 17 from the outside. In the arrangement shown, as one example, thermal medium 36 is made from recycled plastic. However, any other material capable of heat transfer resistance, as a thermal medium 36, is hereby contemplated for use.

In one arrangement, as is shown, body 12 includes a plurality of pinch points 38. Pinch points 38 are formed of any suitable size, shape, and design and are configured to provide a user with enhanced ergonomics when gripping body 12. Said another way, the plurality of pinch points 38 enhance the grip of a user so a user can comfortably hold the body 12 of system 10. A plurality of pinch points 38 are present, in the example shown. In the arrangement shown, as one example, a pinch point 38 is located at or near the neck of a bottle 100 while a second pinch point 38 is shown at the midpoint of the body 12. These locations are strategically placed so a user can easily grip the body 12. However any other number of pinch points 38 or location of pinch points along the body 12 and or lid 54 are hereby contemplated for use.

In the arrangement shown, as one example, body 12 includes an exterior surface 26. Exterior surface 26 is formed of any suitable size, shape, and design and is configured to be the outer wall of body 12. In the arrangement shown, as one example, exterior surface 26 includes a plurality of panels 28. Panels 28, in the arrangement shown, as one example, provide an enhanced ergonomic and aesthetic appeal which also adds to the structural rigidity of body 12. Panels 28 are laid at approximate angles adjacent to one another such that they create polygonal shapes along the exterior surface 26 of the body 12. In the arrangement shown, as one example, these shapes take the form, mostly of triangles, rectangles, quadrilaterals, and like. However, any other shapes are hereby contemplated for use such that they are aesthetically pleasing.

In one arrangement, as is shown, body 12 includes other features. These other features include, but are not limited to, an interior surface 21, an exterior surface 26, the exterior surface 26 having a plurality of panels 28, a barkey home 30 or attachment feature 30, a magnet 32 or a barkey attachment means 32. Additionally, in the arrangement shown, as one example, the body 12 may include a display area 34, and a plurality of pinch points 38.

Bottom Cover:

In the arrangement shown, as one example, system 10 includes a bottom cover 40. Bottom cover 40 is formed of any suitable size, shape, and design and is configured to hold a beverage container within the hollow interior 17 of the body 12 of system 10. Additionally, bottom cover 40 is configured to adjust to different sizes of beverage containers such that the bottom cover 40 can be threadably connected at varying degrees within the body such that a beverage container can be pressed against the interior surface 21 of the body 12 by screwing and/or threadably attaching the bottom cover 40 to the connecting feature 22 of the body 12. Said another way, the bottom cover 40 allows for varying levels of attachment. These varying levels of attachment allow system 10 to accommodate bottles of slightly varying sizes such that the bottles or beverage containers can be fit snuggly and/or within close and tight tolerances on the hollow interior 17 of the body 12. In this way, rattling or movement of the bottle and/or beverage container within the hollow interior 17 is prevented.

In the arrangement shown, as one example, bottom cover 40 includes a top 42, a bottom 44, a handle 46, a thread 48, a detent ring 50, and a thermal medium 52, among other components. In the arrangement shown, as one example, bottom cover 40 is sized and shaped to be positioned along the interior of the lower portion of the hollow interior 17 of the body 12 and be held in place there by the thread 48 of the bottom cover 40 and connection feature 22 engaging one another.

In the arrangement shown, as one example, bottom cover 40 includes a handle 46. Handle 46 may be formed of any suitable size, shape, and design and is configured to provide a user with a means of gripping the bottom cover 40 and if necessary a means of twisting and/or spinning the bottom cover 40 such that the bottom cover 40 can be threadably connected to the connection feature 22 of the body 12. In the arrangement shown, as one example, handle 46 is a protrusion extending outwardly from the bottom 44 of the bottom cover 40. In the arrangement shown, as one example, handle 46 is shaped as a circular protrusion. Said another way, handle 46 is shaped like the edge of a circular disc extending outwardly from the bottom 44 of the handle 46. While this form of a handle 46 is shown, any other form of a handle 46, which assists with the connecting of the bottom cover 40 and the body 12, is hereby contemplated for use, whether in a threadable connection or otherwise.

In the arrangement shown, as one example, bottom cover 40 includes a detent ring 50. Detent ring 50 is formed of any suitable size, shape, and design and is configured to compress a beverage container firmly to the body. In this way, detent ring 50 reduces “rattle” significantly and also prevents the bottom cover 40 from self-turning lose and/or freeing from connection with the connection feature 22 of body 12. In the arrangement shown, as one example, detent ring 50 is also configured to unscrew or threadably disconnect the bottom cover 40 by rotating the beverage container from above, or in one example, by rotating the neck of a bottle 100. In this way, it is possible to remove a beverage container and/or insert a beverage container and/or bottle within the hollow interior 17 of the body 12 with one hand and/or less than two hands by holding the body 12 firmly. In this way, due to surface tension between the rubber ring and the beer bottle, the user has a plurality of various methods of loading, unloading, or reloading the beverage insulator system 10. In the arrangement shown, as one example, detent ring 50 is formed of a circular rubber ring housed in the top 42 of bottom cover 40. In the arrangement shown, as one example, detent ring 50 is formed of a rubber or silicone or recycled plastic. However, any other material including a polymer, composite, foam, and/or the like are hereby contemplated for use.

Lid:

In the arrangement shown, as one example, system 10 includes a lid 54. Lid 54 is formed of any suitable size, shape, and design and is configured to enclose the upper end of the body 12. Said another way, lid 54 encloses the top portion of the opening at the upper end 14 of body 12. Said yet another way, lid 54 encloses a top portion of a beverage container within the hollow interior 17 of the body 12. Said yet another way, lid 54 encloses the top portion of a beverage container. In the arrangement shown, as one example, lid 54 is generally circular in shape when viewed from above and matingly engages the upper end 14 of the body 12.

The lid 54 may include a hinge 72. Hinge 72 aligns on one side of the lid 54 matingly connecting the lid 72 to the body 12. In this way, lid 54 can be locked in a closed position, perhaps by a button 74 and/or other release mechanism. In this way, lid 54 can be locked in a closed position by button 74, while releasing button 74 allows lid 54 to be opened upon hinge 72 thereby providing access to the hollow interior 17 of body 12 and/or the top portion of beverage container so the beverage inside beverage container can be accessed.

In the arrangement shown, as one example, lid 54 extends from a top 56 to a bottom 58 and has an exterior surface 62 and an interior surface 60. In the arrangement shown, as one example, the interior surface 60 or inner wall 64 extend upward from the bottom 58 of the lid 54. The inner wall 64 extends upward until it reaches the top 78 of the cap 76.

In the arrangement shown, as one example, lid 54 includes a cap 76. Cap 76 is formed of any suitable size, shape, and design and is configured to provide an enclosure which engages the beverage container in close and tight tolerances. In one example, as is shown, cap 76 is shaped like the upper portion of a common 12 oz. standard bottle and/or beer bottle. In this way, cap 76 is shaped to enclose the top of a beer bottle, whether the beer bottle cap has been removed or is still in place at the top of the beer bottle.

In the arrangement shown, as one example, cap 76 protrudes from the interior surface 60 of lid 54 in a downward direction. In this way, cap 76 is positioned such that cap can cover a pour spout of a beverage container. The arrangement shown, is one example of a cap 76. The arrangement shown, as one example shows a cap 76 for use with an average beer bottle. However, other cap 76 designs are hereby contemplated for use, including but not limited to, aluminum can caps 76, soda bottle caps 76, or any other beverage container shape which would accommodate a cap 76 capable of providing a seal and/or close and tight tolerances so as to seal and/or prevent heat transfer from the outside to the beverage container. Any other form of a lid 76 is hereby contemplated for use.

In the arrangement shown, as one example, lid 54 is made of rubber and/or recycled plastic. However any other material suitable for protection from drop, sealing and/or serving as the reduction of heat transfer is hereby contemplated for use as a material to be used in the lid 54 to cover, protect, and/or enclose system 10. In addition, the material composition of the bottom cover 40 contributes to the lightweight design of system 10.

In the arrangement shown, as one example system 10 includes other features. These features include a barkey 80, the barkey having a tab 82, an opener 84, and a point 86. Other features shown, as one example are a bottle 100. This bottle, shown as one example, is a beverage container of average size for a 12 oz beer as is most commonly found in production. System 10 may include a plurality of other features, including but not limited to a can or other beverage container. In one arrangement, as is shown, a magnetically detachable and rigid “barkey” and/or bottle opener is attached to the exterior surface 26, via magnetic connection, of the body 12.

Process of Making:

With reference to the figures, and with reference to the disclosure herein, a process of making a beverage insulator system 10 is presented. In the arrangement shown, as one example, the primary material used in the process of making of system 10 is an injection molded inner wall, a blow molded and trimmed outer wall, and a filled PU foam thermal insulation layer between the inner wall and the outer wall. This process of making allows for maximum retardation of conducted heat loss through application of inherently insulating plastics, as well as the excellent thermal resistance properties of PU foam between the inner wall and the outer wall. Furthermore, by injecting foam, the plastic parts are welded in place during assembly.

Another process of manufacturing the system 10 includes printing a logo 98 and/or other indicia on a panel or exterior surface of the body 12. This process may include printing a logo and/or other indicia on a film laminate that is then attached to the exterior surface and/or another means of printing and or attaching a logo and/or other indicia onto the exterior surface of the body 12 of system 10. An alternative method of logo attachment may be screenprinting the logo onto plastic anywhere on the body 12 and/or other components of system 10. This enables a user to produce system 10 and create recognizable branding and/or sponsoring.

This process of making provides an enhanced user experience. Additionally, this process of making increases the life of the product. Additionally, this process of making is environmentally friendly. Additionally, this process of making reduces plastic pollution. Additionally, this process of making reduces plastic waste existing in the environment. Additionally, this process of making gives a user flexibility in the features of system 10. Additionally, this process of making gives a user the ability to customize the appearance of system 10. Additionally, this process of making allows for a design which is more ergonomically friendly than beverage insulators that are known in the art. Additionally, this process of making allows for natural pinch points, as well as a for a plurality of pinch points to be used. Additionally, this process of making makes gripping easier and more comfortable for a user. Additionally, this process of making creates a plastic bottom cover 40 which secures in place with ultra-course thread which is easy to insert (only requiring 2-3 turns, more, or even less)and features embedded rubber detent ring 50 which compresses bottle and, through inherent surface tension, prevents bottom cover 40 from self-turning loose.

In Use:

In many circumstances, a user may desire to maintain the temperature of a beverage at something other than ambient temperature; whether this is keeping a beverage or substance warm/hot or keeping a beverage/substance cold, by comparison.

As one example, in one method of use, a user desiring to maintain the cold temperature of a bottle starts by removing the bottom cover 40 from the lower portion of the body 12 of system 10. In the arrangement shown, as one example, the user removes the bottom cover 40 by twisting and/or threadably removing the bottom cover 40 from the connection feature 22 of the body 12. This exposes the hollow interior 17 of the body 12. Once exposed, the user can place a bottle 100, neck side up into the hollow interior 17 of the body 12.

Once the bottle 100 is in place within the hollow interior 17, the user twists and/or threadably reattaches the bottom cover 40 so as to press the beverage container upward into close and tight tolerances within the hollow interior 17 such that the beverage container is securely in place within the hollow interior 17. In this arrangement, as is shown in one example, the “shoulder” of the beer bottle comes into secure contact with the tapered section of the sidewall 18 such that the “neck” of the bottle also engages contact with the sidewall 18. The user can adjust the bottom cover 40 to any number of turns such that the beer bottle, ranging in size from producer, fits snugly and/or within close and tight tolerances. Once the desired snugness is obtained by twisting the bottom cover 40 enough revolutions, the bottom cover 40 is secured. The detent ring 50 will prevent the bottom cover 40 from becoming un-secure and will maintain the position of the beverage container within the hollow interior 17 of the body 12.

Once the bottle and/or beverage container is secure, a user may desire to remove a cap from the bottle or open the beverage container. If a bottle is in place with a cap, a user may remove the barkey 80 from magnetic engagement with the exterior surface 26 of the body 12. The user may then use the barkey 80 to remove the cap from the bottle 100. Once the cap is removed from the bottle, the barkey 80 can be replaced against the exterior surface 26 and or frictionally fit within an opening in the exterior surface 26 for use at a later time or with another bottle 100 and/or can 102 and or other beverage container.

Once the beverage container is in place and the barkey has been returned to its holding place within and/or on system 10, the user may grip the body 12 and or system 10 for consumption, transport, or handling. As one example, as is shown, body 12 includes a plurality of pinch points 38. Pinch points 38 are formed of any suitable size, shape, and design and are configured to provide a user with enhanced ergonomics when gripping body 12. Said another way, the plurality of pinch points 38 enhance the grip of a user so a user can comfortably hold the body 12 of system 10. A plurality of pinch points 38 are present, in the example shown. In the arrangement shown, as one example, a pinch point 38 is located at or near the neck of a bottle 100 while a second pinch point 38 is shown at the midpoint of the body 12. These locations are strategically placed so a user can easily grip the body 12.

These pinch points enable a user to grip the body 12 at the neck and/or midpoint while consuming a beverage from the beverage container held within the hollow interior 17 of the body 12. In addition to using the pinch points 38 with ergonomic advantages, the material and design of system 10 is lightweight. This further creates a comfortable means of using system 10 in association with the consumption, transportation, or storing of a beverage within a beverage container within the hollow interior 17 of the body 12. Additionally, while the example shows a beverage container and/or bottle within the hollow interior 17 of the body 12, it is hereby contemplated for use that a beverage could be placed directly within the hollow interior 17 of the body 12. When the beverage is consumed or at a point in time the user desires to replace the beverage container and/or bottle 100 within the hollow interior 17 of the body 12, the user merely repeats the process, only this time, adding the step of removing the bottle 100 and/or beverage container already within the hollow interior 17 of the body 12.

If a user desires to use the lid 54 with the beverage container in place, the user may frictionally fit the lid 54 to the upper end 14 of the body 12 such that the cap 76 of the lid 54 engages the top of the beverage container with close and tight tolerances for safety and/or to seal the contents within the beverage container. This enables the user to transport system 10 along with the beverage container and contents. Additionally, this allows the user to drop, bump, bang, and/or tip system 10 in ways that system 10 does prevent the beverage container from breaking and/or leaking any contents. This prevents messes, damage, and safety concerns.

In another example, as another method of use, bottom cover 40 includes a detent ring 50. Detent ring 50 is formed of any suitable size, shape, and design and is configured to compress a beverage container firmly to the body. In this way, detent ring 50 reduces “rattle” significantly and also prevents the bottom cover 40 from self-turning lose and/or freeing from connection with the connection feature 22 of body 12. In the arrangement shown, as one example, detent ring 50 is also configured to unscrew or threadably disconnect the bottom cover 40 by rotating the beverage container from above, or in one example, by rotating the neck of a bottle 100. In this way, it is possible to remove a beverage container and/or insert a beverage container and/or bottle within the hollow interior 17 of the body 12 with one hand and/or less than two hands by holding the body 12 firmly. In this way, due to surface tension between the rubber ring and the beer bottle, the user has a plurality of various methods of loading, unloading, or reloading the beverage insulator system 10. In the arrangement shown, as one example, detent ring 50 is formed of a circular rubber ring housed in the top 42 of bottom cover 40. In the arrangement shown, as one example, detent ring 50 is formed of a rubber or silicone or recycled plastic. This enables a user to remove the beverage container and replace the beverage container with a single hand or less.

It will be appreciated by those skilled in the art that other various modifications could be made to the device without parting from the spirit and scope of this disclosure. All such modifications and changes fall within the scope of the claims and are intended to be covered thereby.

1. A beverage insulator, comprising:
a body;
the body having an interior surface and an exterior surface;
the body having an interior;
wherein the body is configured to receive a container therein;
the body having a thermal medium;
a bottom cover;
wherein the bottom cover is configured to attach to the body;
a lid;
wherein the lid operably attaches to the body.

2. The system of claim 1, further comprising:
a plurality of panels angularly arranged forming the exterior surface of the body.

3. The system of claim 1, further comprising:
a plurality of panels;
wherein the plurality of panels form a series of triangles when viewed from the side.

4. The system of claim 1, further comprising:
a plurality of panels;
wherein each of the plurality of panels consists of three sides.

5. The system of claim 1, further comprising:
a barkey.

6. The system of claim 1, further comprising:
a barkey;
a magnet integrated into the exterior surface of the body;
wherein the barkey is removeably secured against the exterior surface of the body.

7. The system of claim 1, further comprising:
the bottom cover rotationally fit within the bottom of the bottle insulator.

8. The system of claim 1, further comprising:
the bottom cover configured with a snap fit;
wherein the bottom cover snaps into place at a lower portion of the body.

9. The system of claim 1, further comprising:
the bottom cover configured to rotationally secure a bottle within the interior of the body.

10. The system of claim 1, further comprising:
the body formed of an injection molded insulation.

11. The system of claim 1, further comprising:
the body having a blow molded outer wall;
wherein the blow molded outer wall includes a plurality of panels;
the body having a filled foam thermal insulated layer;
wherein the foam thermal insulated layer is injection molded into the interior using the blow molded outer wall.

12. The system of claim 1, further comprising:
a plurality of pinch points;
wherein the pinch points are formed at obtuse angles to one another.

13. A process of making a beverage insulator, the steps comprising:
molding a composition into a body with an interior.

14. The process of making a beverage insulator of claim 13, further comprising the steps:
molding an outer wall;
injecting an interior with an injection molding.

15. A method of using a beverage insulator system, the steps comprising:
providing a beverage insulator system having a body, a bottom cover, and a lid;
providing a beverage container having a substance therein;
placing the beverage container within an interior of the body;
enclosing the beverage container with the interior of the body by threadably attaching the bottom cover to the body;
enclosing a top of the beverage container by attaching the lid to the body;
insulating the beverage container therein.

16. The method of claim 15, further comprising the steps:
gripping the beverage insulator system at pinch points; wherein the pinch points are optimally angled for grip.

17. The method of claim 15, further comprising the steps:
gripping the beverage insulator system at pinch points; wherein the pinch points are formed of a plurality of panels;
angling the plurality of panels each away from one another at an angle of 120 degrees.

18. The method of claim 15, further comprising the steps:
gripping the beverage insulator system at pinch points; wherein the pinch points are formed of a plurality of panels;
angling the plurality of panels each away from one another at an angle of 130 degrees.

19. The method of claim 15, further comprising the steps:
gripping the beverage insulator system at pinch points; wherein the pinch points are formed of a plurality of panels;
angling the plurality of panels each away from one another at an angle of 140 degrees.

20. The method of claim 15, further comprising the steps:
gripping the beverage insulator system at pinch points; wherein the pinch points are formed of a plurality of panels;
angling the plurality of panels each away from one another at an angle of 150 degrees.
